(19) United States
(12) Patent Application Publication
(10) Pub. No.: US 2023/0140108 A1
(43) Pub. Date: May 4, 2023

(54) MANAGING UNLOCK AND DISCONNECT EVENTS BETWEEN CONNECTED DEVICES

(71) Applicants: Shuki Perlman, Zur-Hadassa (IL); Chia-Hung Sophia Kuo, Folsom, CA (US); Antonio S. Cheng, Portland, OR (US); Moorthy Rajesh, Folsom, CA (US); Sathvik Reddy Gaddam, Garden Grove, CA (US); Glen J. Anderson, Beaverton, OR (US)

(72) Inventors: Shuki Perlman, Zur-Hadassa (IL); Chia-Hung Sophia Kuo, Folsom, CA (US); Antonio S. Cheng, Portland, OR (US); Moorthy Rajesh, Folsom, CA (US); Sathvik Reddy Gaddam, Garden Grove, CA (US); Glen J. Anderson, Beaverton, OR (US)

(21) Appl. No.: 18/089,336

(22) Filed: Dec. 27, 2022

(51) Int. Cl. G09G 5/00

(52) U.S. Cl. CPC G09G 5/006; G09G 2370/16

(57) ABSTRACT

Various systems and methods for controlling states of a portable device when connected with a wireless display device are described herein. A portable device is configured to initiate establishment of a wireless connection between the portable device and a wireless display device for the portable device to cast output to the wireless display device; receive an indication of a user absent event, the user absent event triggered by human presence sensing circuitry of the wireless display device; determine whether an exception exists; and control a state of the portable device based on whether the exception exists.

### TECHNICAL FIELD

Embodiments described herein generally relate to computing devices, and in particular, to managing unlock and disconnect events and communication of such events between connected devices.

### BACKGROUND

Mobile computing and workshare experiences are becoming commonplace in today's modern workforce. Through the proliferation of cloud services, document collaboration software, remote access, and lightweight computing devices, a technology worker is able to work from nearly anywhere in the world that has network connectivity. Internet cafes, co-working spaces, shared workplaces, and other types of venues provide group and individual working spaces along with various amenities, such as meeting rooms, printing services, high-speed internet access, food and beverage services, and hardware rentals.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a diagram illustrating a workshare operating environment, according to an embodiment;

FIG. 2 is a block diagram illustrating components of a portable device and a wireless display device, according to an embodiment;

FIG. 3 is flowchart illustrating a process for a lock-resume-disconnect flow, according to an embodiment;

FIG. 4 is flowchart illustrating a process for controlling states of a portable device when connected with a wireless display device, according to an embodiment; and

FIG. 5 is a block diagram illustrating an example machine upon which any one or more of the techniques (e.g., methodologies) discussed herein may perform, according to an embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

In some co-working spaces, large format displays or monitors are available for use. The displays may be used in place of or in tandem with a portable device, for example, for easier viewing of content by a user who brings a device, such as a laptop, to a co-working space to work. While displays may have conventional connections, such as through High-Definition Multimedia Interface (HDMI), Universal Serial Bus Type C (USB-C), Digital Visual Interface (DVI), or other physical connectors, more displays are supporting wireless connectivity. Various standards are available to connect a computer to a display over a wireless connection. These include but are not limited to Wireless HDMI, Miracast™ based on Wi-Fi Direct®, AirPlay by Apple Inc., Chromecast™ by Google LLC, and others.

With wireless connectivity, users can easily interact with workstations in a co-working site. For instance, a co-working site may provide workstations that have a display, keyboard, and mouse, in a “bring your own compute device” model. Depending on the configuration, a user who may frequently visit a particular co-working site may be able to leave their portable device (e.g., laptop) in their bag while approaching and working at a workstation. During the work session, the user's portable device can connect to the display at the workstation, with the portable device providing the compute, network, and storage facilities needed for the user to perform their tasks. The user may interact with the portable device through an input device (e.g., keyboard and mouse) that are paired or physically connected to the display. Alternatively, the user may use a keyboard, mouse, or other input device that is paired to the portable device. This arrangement streamlines the user experience and reduces friction when the user is engaging and disengaging from the co-working space.

In a co-working space, security is an important factor. With wireless sharing and connections, there is a risk that the user's connection is shared to the wrong display device or that the connection is still active even after the user is finished with their task, but is still within communication range of the wireless display. Thus, there is a need to provide enhanced security to ensure user privacy.

The systems and techniques described herein provide for a reliable and secure solution to lock the portable device when the user walks away from the wireless display, unlock the portable device when the user returns to proximity of the wireless display within a threshold period, and disconnect the portable device from the wireless display when the user departs from the workstation. The systems and techniques include use of a combination of sensors that may be on the portable device, the wireless display, or installed in the workstation environment. In an example implementation, motion sensors from the portable device are used in combination with proximity sensors on the wireless display to determine whether the portable device should transition to a locked state, an unlocked state, or be disconnected from the wireless display. Additional details are described in the example embodiments discussed below.

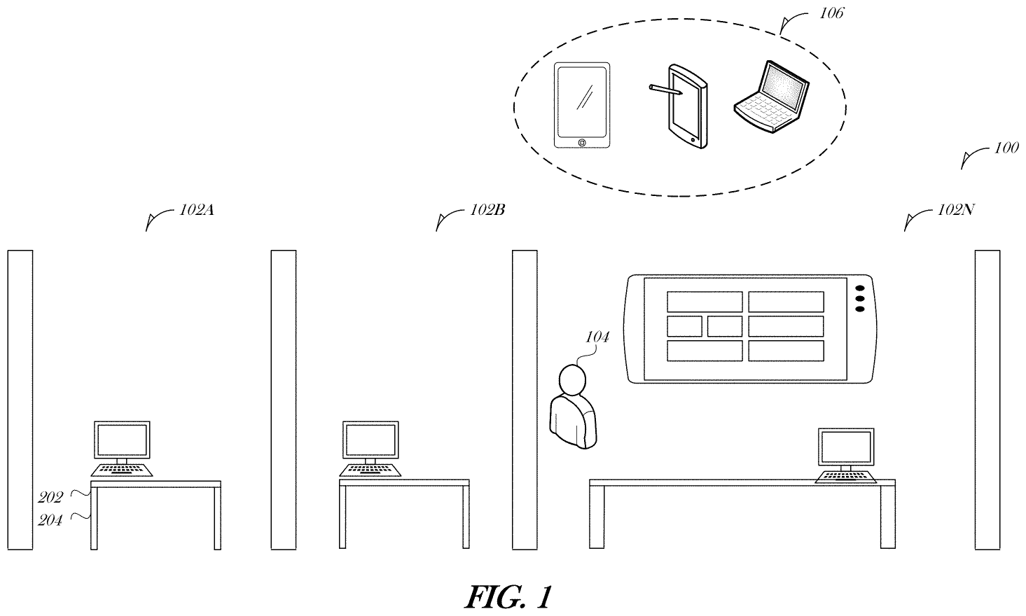

FIG. 1 is a diagram illustrating a workshare operating environment 100, according to an embodiment. The workshare operating environment 100 includes a number of work areas 102A, 102B, . . . , 102N (collectively referred to as 102). The work areas 102 may be configured substantially the same or may each have different features. For instance, work area 102A and work area 102B include a table, a computer display, and input devices (e.g., a mouse and keyboard), while work area 102N includes a conference table, a computer display, input devices, and an electronic whiteboard. To use a work area 102, a user 104 may sign up, rent, reserve, be assigned, or otherwise be associated with a particular work area 102. The user 104 may be provided an access code, a bar code, a passcode, a password, or other identifying information to use on their portable device (e.g., laptop computer, tablet computer, mobile phone, hybrid computer) to access the resources of the work area 102. The information used to access the resources of the work area 102 may also unlock or provide access to shared resources. Shared resources, such as printers, fax machines, copiers, scanners, or the like, may be made available to any person who has access to work area 102.

In the case where a user 104 has previously used a work area 102, then the user 104 may have an account with the provider of the work areas 102, and be able to access the work areas 102 whenever convenient for the user 104. The user 104 may have one or more portable devices 106, such as a laptop, a tablet, and a mobile phone, that have already been paired or discovered by the resources in the work area 102, such that when the user 104 approaches, the portable device (s) 106 may connect to input devices (e.g., keyboard and mouse) and output devices (e.g., monitor or display device) for streamlined access.

In an example use case, the user 104 approaches a work area 102 and the user's laptop 106 connects to the input devices and display at the work area 102. The input devices may be previously paired over a short-range wireless connection, such as Bluetooth. The display may be paired with the user's laptop using a Wi-Fi-based connection. The user 104 may sit at the table in the work area 102 and use the compute, storage, and network resources of their laptop 106 with the input and output devices of the work area 102.

While connected, the user 104 may decide to walk away from the work area 102. While maintaining the connection with the wireless display, the laptop device 106 is locked when the user 104 is detected to be absent for more than a threshold time or when the user 104 is detected to be farther than a threshold distance from the work area 102. The user's presence is detected with sensors that are installed in the display at the work area 102. This may be referred to as a “walk away lock” mechanism.

The sensors used to determine user presence or proximity may include cameras, infrared proximity sensors, keyboards, mice, touchpads, or other input devices. For instance, mouse movement may be used to indicate that the user 104 is still present at the work area, even if the user is not visible in a camera's field of view. The sensors may be built into the display. For instance, a camera or other optical sensor may be installed in a bezel area of a display's panel. Alternatively, the sensors may be connected to the display, for instance, an external camera (e.g., webcam) may be connected to a display using a USB connection at the rear of the display.

Sensors installed or connected to the user's portable device 106 may also be used in conjunction with environmental sensors at the work area 102. The portable device's sensors may include an accelerometer, gyrometer, global positioning service (GPS) sensor, or other positioning sensor, and may be used to determine whether the portable device 106 is being moved or has been moved. Movement of the portable device 106 may indicate that the user 104 is leaving the work area 102.

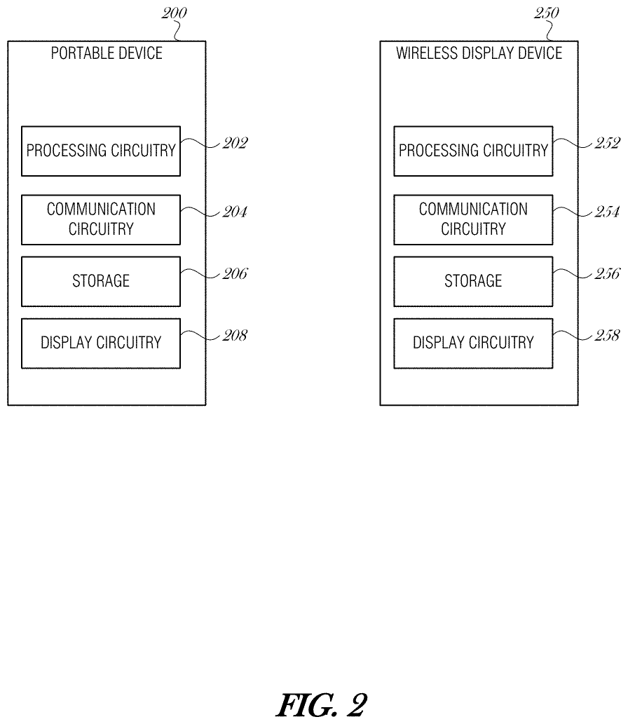

FIG. 2 is a block diagram illustrating components of a portable device 200 and a wireless display device 250, according to an embodiment. The portable device 200 is an electronic device that includes processing mechanisms, storage mechanisms, and communication mechanisms. The portable device 200 may be a laptop, smartphone, mobile phone, tablet device, smart watch, or other mobile or wearable device. The portable device 200 includes processing circuitry 202, communication circuitry 204, storage 206, and display circuitry 208.

The processing circuitry 202 may include a mobile processor, which uses less power and is designed for prolonged battery use. Example mobile processors include the Snapdragon line of processors by Qualcomm, the A-series Bionic processors by Apple, and low-power variants of desktop processors by Intel, AMD, or ARM.

Communication circuitry 204 is used to communicate over wireless connections, including the IEEE 802.11 family of standards. The communication circuitry 202 may be used to interface with a transceiver, such as a Wi-Fi transmitter or a Wireless HDMI transmitter, in order to transmit video and control data to wireless display (e.g., wireless display device 250).

Storage 206 may include one or more volatile or non-volatile storage devices, including a random-access memory (e.g., DRAM, SRAM), a solid-state drive (SSD), a USB flash drive, or a Secure Digital (SD) memory card. The storage 206 is used to store instructions for the processing circuitry 202 to execute an operating system or other applications or routines, store state data, store video frame data, store control data, and the like.

Display circuitry 208 is used to present images and video on a display device, which may take various forms depending on the form factor of the portable device 200. For instance, a display device may include a light-emitting diode (LED) panel, an organic light-emitting diode (OLED) panel, or the like. The display device may be integrated into the portable device 200, such as in the case of a tablet or smartphone device, or may be a separate device that is connected to the portable device.

The wireless display device 250 is capable of wireless display technology. The wireless display device 250 may support various wireless display protocols, such as Miracast™, wireless HDMI, Bluetooth, or WiGig wireless. Other wireless display protocols may be implemented or supported with the wireless display device 250. The wireless display device 250 includes processing circuitry 252, communication circuitry 254, storage 256, and display circuitry 258. The processing circuitry 252 is used to execute

Processing circuitry 252 may include a processor. The processor may be a low-power variant like the processing circuitry 202 used in portable device 200, or may be a desktop processor. Alternatively, the processing circuitry 252 may be a custom designed system on chip (SOC) to control the wireless display device 250.

Communication circuitry 254 is used to communicate over wireless connections, including the IEEE 802.11 family of standards. The communication circuitry 252 may be used to interface with a transceiver, such as a Wi-Fi receiver or a Wireless HDMI receiver, in order to receive video and control data wirelessly from a device (e.g., portable device 200).

Storage 256 may include one or more volatile or non-volatile storage devices, including a random-access memory (e.g., DRAM, SRAM), a solid-state drive (SSD), a USB flash drive, or a Secure Digital (SD) memory card. The storage 256 is used to store instructions for the processing circuitry 252 to execute an operating system or other applications or routines, store state data, store video frame data, store control data, and the like.

Display circuitry 258 is used to present images and video on the wireless display device 250. The wireless display device 250 may include a light-emitting diode (LED) panel, an organic light-emitting diode (OLED) panel, cathode-ray tube (CRT), or the like. The wireless display device 250 may be integrated into general computing device, such as an all-in-one (AIO) computer, or be standalone device used primarily as an output device (e.g., a smart display, smart television, etc.).

In use, the portable device 200 may perform a discovery operation to identify the wireless display device 250, authenticate to the wireless display device 250, and connect or pair to the wireless display device 250. The portable device 200 may identify, authenticate, and connect/pair to the wireless display device 250 automatically after an initial relationship (e.g., pairing) has been established. In this manner, the user of the portable device 200 may easily approach a previously-used workstation with the wireless display device 250, sit down and start working using the wireless display device 250 and input devices that are connected to their portable device 200. The user may even perform these operations without removing the portable device 200 from a carry bag or briefcase, unlocking the portable device 200, or otherwise having to interact directly with the portable device 200. This mode of connection and use streamlines the user's experience.

After the portable device 200 and wireless display device 250 are connected, the portable device 200 provides the output to the wireless display device 250 for presentation. For instance, the portable device 200 may be a smartphone with a player application (e.g., YOUTUBE®), and the video playback from the player application is mirrored or broadcasted to the wireless display device 250 for presentation. As another example, the user's portable device 200 may be a laptop device and the wireless display device 250 acts as a secondary display device for the laptop to mirror the desktop or expand the desktop to the secondary display.

Input devices may be provided at the common workspace. The input devices may include various pointer devices (e.g., trackball, mouse, trackpad, etc.) or alphanumeric input devices (e.g., keyboard, virtual keyboard on a touchscreen, etc.). The portable device 200 may establish (or cause the establishment of) a wireless connection with the input devices (e.g., using BLUETOOTH), and the user may then use the input devices to control the portable device 200—even while the portable device 200 is still in its carrying bag or briefcase, for example.

When the portable device 200 and wireless display device 250 are connected, sensors that are connected to the wireless display device 250 provide data back to the portable device 200 using a wireless link back-channel. The sensors may include a camera, proximity sensor, or other sensor capable of detecting the user's presence that is communicatively attached or integrated with the wireless display device 250. The portable device 200 uses the sensor data from the wireless display device 250 along with its own sensor data, fusing the two sensor data, to determine whether the user is proximate to the wireless display device 250 or whether the portable device 200 is being moved. Based on the sensor data, the portable device 200 may initiate one or more security operations to secure the portable device 200.

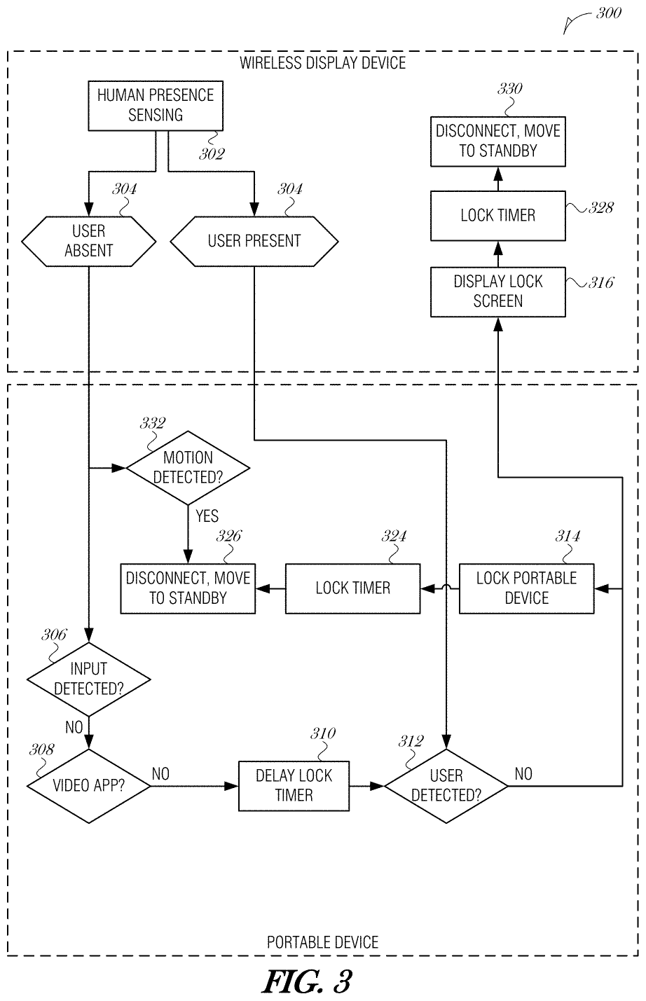

FIG. 3 is flowchart illustrating a process 300 for a lock-resume-disconnect flow, according to an embodiment. At 302, a wireless display device provides human presence sensing. This may be performed using proximity sensor circuitry in the wireless display device. This is used to determine whether the user is present at the workstation. When the user leaves the working space, a user absent event 304 is generated by the proximity sensor circuitry. The user absent event 304 is transmitted to the portable device on a wireless backchannel and is used to trigger a lock or disconnect flow at the portable device. The backchannel may be provided over a different wireless channel than the video data. For instance, a Bluetooth backchannel may be established to communicate the events from the wireless display device to the portable device. The user absent event 304 may also be used locally at the wireless display device to initiate a state transition of the wireless display to a locked, suspended, hibernated, or powered off state.

The user may leave the workstation for various reasons. For instance, the user may move away from the working space for a short time with the intent to return and resume work using the screen sharing system. In this case, the user may not take the portable device when the user is away briefly. In another instance, the user may leave the working space and plan to continue working on the portable device in another location (e.g., in another office). In this case, the user likely takes the portable device along because they are finished working at the shared working space.

In order to avoid user inconvenience, the user absent event is used to initiate additional checks before the wireless display device or the portable device are locked or disconnected. At 306, it is determined whether there is any input control detected (e.g., mouse movement, keyboard activity, touchscreen activity, etc.) in a threshold period after the user absent is triggered. The inputs may be detected by either input received at the wireless display device or the portable device, for input devices that are connected to one or the other, respectively. Indications of input received at the wireless display device may be transmitted via a backchannel to the portable device. These input events may not be used as inputs to control the user interface at the portable device, but instead just indications of activity at the wireless display device. The indications of inputs received at either the wireless display device or the portable device are used to interrupt the walk away lock.

If input is detected during the threshold period, then the portable device may reset the walk away lock mechanism. As such, the user is able to continue work without noticing any interruption and the process 300 returns to the human presence sensing operation 302. The threshold period may user configurable. The threshold period may be any period, such as 5 seconds, 10 seconds, 2 minutes, etc.

If the threshold period expires, then at 308, the portable device determines whether a video application is the foreground application (e.g., active application). An active video application is another exception where the user experience should not be interrupted due to a lack of movement or user presence in proximity to the wireless display device. If there is an active video application (e.g., streaming or video playback from local memory) running on the portable device, the process 300 returns to the human presence sensing operation 302 and no additional action is taken due to the user absent event. The video application exception is optional and may be omitted in some flows.

In the case where there is not an active video application, then a delay timer is initiated to watch for a user present event (operation 310). This provides some grace period before locking the system to handle cases such as false user absent trigger event, such as where the user returned to be in front of the wireless display device during the pre-defined delay timer period. The delay timer period may be user configurable. The delay timer period may be any period, such as 5 seconds, 10 seconds, 2 minutes, etc. If the user is detected, then the wireless display device and the portable device are not locked and the user may continue working in the workstation.

If the user present event is not detected (operation 312), then the process 300 continues to operation 314, where one or both of the wireless display device and the portable device is locked. The two platforms are still connected. The portable device and/or the wireless display device may display a lock screen or login screen. For instance, the wireless display device may display a lock screen message with a quick response (QR) code to unlock the wireless display device and reestablish screen casting (operation 316). To reconnect, the user may scan the QR code with a phone or tablet, for example. The QR code along with any other user credentials needed (e.g., a username and password) are checked to authenticate the user and reconnect the wireless display device to the portable device.

When in the lock state, the portable device will stay in a lock state for pre-defined time (operation 324) before disconnecting the wireless link and moving to standby power state to save battery life (operation 326). As stated, for reducing the impact on battery power and for better security, any significant motion event detected during the pre-lock and lock phases will cause the portable device to stop the screen sharing, disconnect the link, and move to standby power mode (operation 326).

Similarly, if the wireless display device is locked for longer than a threshold period (operation 328), then the connection between the wireless display device and the portable device is terminated and the display device is moved to a standby power mode (operation 330).

If after the user absent event is detected, the portable device detects significant motion event via its embedded sensors (e.g., the portable device has experienced more than a threshold distance from its position last position) (operation 332), then the portable device will stop the screen sharing, disconnect the wireless link, and transition to standby power mode (operation 326). The threshold distance may be user configurable.

It is understood that either the wireless display device or the portable device may generate the user absent event or the user present event using sensor data collected from the wireless display device. For instance, onboard processing may be used by the wireless display device to perform human presence sensing. Alternatively, sensor data may be provided to the portable device via a wireless backchannel, and the portable device may perform the assessments for whether the human presence is absent for a threshold period to trigger a user absent event or whether human presence is detected again to trigger a user present event.

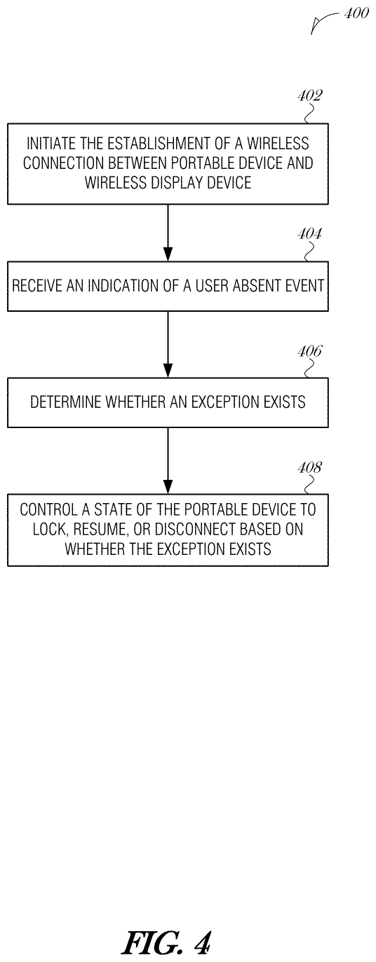

FIG. 4 is flowchart illustrating a process 400 for controlling states of a portable device when connected with a wireless display device, according to an embodiment. The process may be performed by a portable device (e.g., portable device 200) or a display device (e.g., wireless display device 250).

At 402, a wireless connection between the portable device and the wireless display device is initiated and established for the portable device to cast output to the wireless display device. To cast output includes technologies such as screen casting, screen mirroring, screen extending, duplicating screens, or the like. In an embodiment, the wireless connection comprises a connection using the Miracast standard. In an embodiment, the wireless display device comprises a smart television, a monitor screen, or an all-in-one desktop computer.

At 404, an indication of a user absent event is received. The user absent event is triggered by human presence sensing circuitry of the wireless display device. In embodiments, the human presence sensing circuitry comprises a camera or an infrared sensor.

In an embodiment, the indication of the user absent event is transmitted to the portable device from the wireless display device over a backchannel wireless connection. In an embodiment, the user absent event is triggered by the human presence sensing circuitry when no one is detected for longer than a threshold period.

At 406, whether an exception exists is determined. In an embodiment, the exception comprises receiving input from an input device connected to the portable device. In a further embodiment, the input device comprises a mouse, a keyboard, or a touchpad. In a further embodiment, the method 400 includes resetting a timer in response to receiving input from an input device connected to the portable device.

In an embodiment, the exception comprises receiving input from an input device connected to the wireless display device. In a further embodiment, the input device comprises a mouse, a keyboard, or a touchpad. In a further embodiment, the method 400 includes resetting a timer in response to receiving input from an input device connected to the wireless display device.

At 408, a state of the portable device to lock, resume, or disconnect is controlled based on whether the exception exists.

In an embodiment, controlling the state of the portable device to lock, resume, or disconnect includes locking at least one of the portable device or the wireless display device in response to no exception having been received in a threshold period after the user absent event.

In an embodiment, the exception comprises receiving an indication of a user present event. In a further embodiment, the user present event is detected by the human presence sensing circuitry in the wireless display device. In a further embodiment, the user present event is based on detecting movement of a person in proximity of the wireless display device. In a further embodiment, controlling the state of the portable device to lock, resume, or disconnect includes resetting a timer in response to receiving the indication of the user present event.

In an embodiment, the exception comprises determining that a video playback application is executing on the portable device with the output displayed on the wireless display device. In a further embodiment, controlling the state of the portable device to lock, resume, or disconnect includes resetting a timer in response to determining that the video playback application is executing on the portable device.

In an embodiment, controlling the state of the portable device to lock, resume, or disconnect includes transitioning the portable device to a standby state after the portable device is locked for more than a threshold period.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the —readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

Circuitry or circuits, as used in this document, may comprise, for example, singly or in any combination, hardwired circuitry, programmable circuitry such as computer processors comprising one or more individual instruction processing cores, state machine circuitry, and/or firmware that stores instructions executed by programmable circuitry. The circuits, circuitry, or modules may, collectively or individually, be embodied as circuitry that forms part of a larger system, for example, an integrated circuit (IC), system on-chip (SoC), desktop computers, laptop computers, tablet computers, servers, smartphones, etc.

As used in any embodiment herein, the term “logic” may refer to firmware and/or circuitry configured to perform any of the aforementioned operations. Firmware may be embodied as code, instructions or instruction sets and/or data that are hard-coded (e.g., nonvolatile) in memory devices and/or circuitry.

“Circuitry,” as used in any embodiment herein, may comprise, for example, singly or in any combination, hardwired circuitry, programmable circuitry, state machine circuitry, logic and/or firmware that stores instructions executed by programmable circuitry. The circuitry may be embodied as an integrated circuit, such as an integrated circuit chip. In some embodiments, the circuitry may be formed, at least in part, by the processor circuitry executing code and/or instructions sets (e.g., software, firmware, etc.) corresponding to the functionality described herein, thus transforming a general-purpose processor into a specific-purpose processing environment to perform one or more of the operations described herein. In some embodiments, the processor circuitry may be embodied as a stand-alone integrated circuit or may be incorporated as one of several components on an integrated circuit. In some embodiments, the various components and circuitry of the node or other systems may be combined in a system-on-a-chip (SoC) architecture

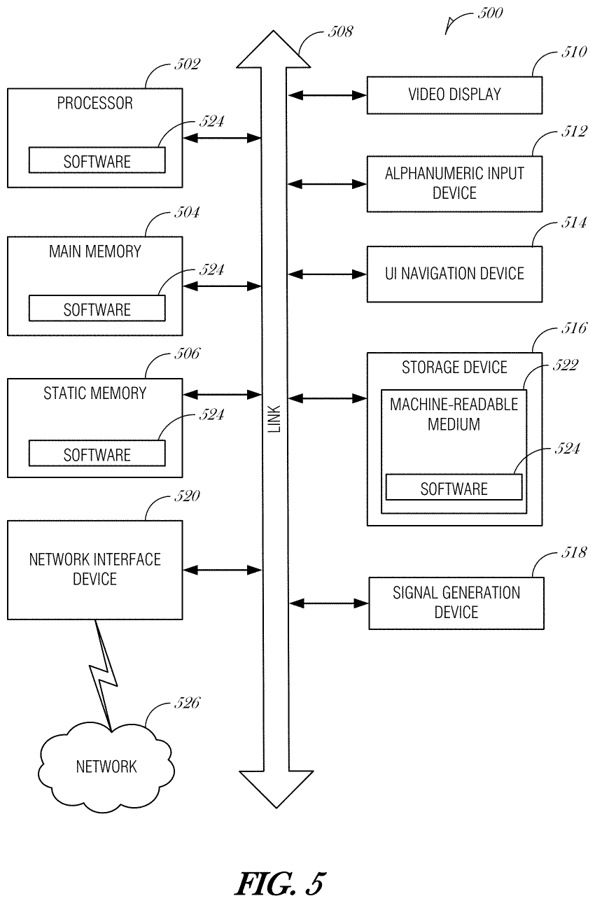

FIG. 5 is a block diagram illustrating a machine in the example form of a computer system 500, within which a set or sequence of instructions may be executed to cause the machine to perform any one of the methodologies discussed herein, according to an embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a vehicle subsystem, a personal computer (PC), a tablet PC, a hybrid tablet, a personal digital assistant (PDA), a mobile telephone, an all-in-one PC, a smart display, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 500 includes at least one processor 502 (e.g., a central processing unit (CPU), a graphics processing unit (GPU) or both, processor cores, compute nodes, etc.), a main memory 504 and a static memory 506, which communicate with each other via a link 508 (e.g., bus). The computer system 500 may further include a video display unit 510, an alphanumeric input device 512 (e.g., a keyboard), and a user interface (UI) navigation device 514 (e.g., a mouse). In one embodiment, the video display unit 510, input device 512 and UI navigation device 514 are incorporated into a touch screen display. The computer system 500 may additionally include a storage device 516 (e.g., a drive unit), a signal generation device 518 (e.g., a speaker), a network interface device 520, and one or more sensors (not shown), such as a global positioning system (GPS) sensor, compass, accelerometer, gyrometer, magnetometer, or other sensor.

The storage device 516 includes a machine-readable medium 522 on which is stored one or more sets of data structures and instructions 524 (e.g., software) embodying or utilized by any one or more of the methodologies or functions described herein. The instructions 524 may also reside, completely or at least partially, within the main memory 504, static memory 506, and/or within the processor 502 during execution thereof by the computer system 500, with the main memory 504, static memory 506, and the processor 502 also constituting machine-readable media.

While the machine-readable medium 522 is illustrated in an example embodiment to be a single medium, the term “machine-readable medium” may include a single medium or multiple media (e.g., a centralized or distributed database, and/or associated caches and servers) that store the one or more instructions 524. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Bluetooth, Wi-Fi, 3G, and 4G LTE/LTE-A, 5G, DSRC, or satellite communication networks). The term “transmission medium” shall be taken to include any intangible medium that is capable of storing, encoding, or carrying instructions for execution by the machine, and includes digital or analog communications signals or other intangible medium to facilitate communication of such software.

### Additional Notes & Examples

Example 1 is a portable device, comprising: a memory configured to store instructions for controlling states of the portable device when connected with a wireless display device; and a processor circuitry, which when configured by the instructions, is operable to: initiate an establishment of a wireless connection between the portable device and the wireless display device for the portable device to cast output to the wireless display device; receive an indication of a user absent event, the user absent event triggered by human presence sensing circuitry of the wireless display device; determine whether an exception exists; and control a state of the portable device to lock, resume, or disconnect the portable device based on whether the exception exists.

In Example 2, the subject matter of Example 1 includes, wherein the wireless connection comprises a connection using the Miracast standard.

In Example 3, the subject matter of Examples 1-2 includes, wherein the wireless display device comprises a smart television, a monitor screen, or a desktop computer.

In Example 4, the subject matter of Examples 1-3 includes, wherein the indication of the user absent event is transmitted to the portable device from the wireless display device over a backchannel wireless connection.

In Example 5, the subject matter of Examples 1˜4 includes, wherein the user absent event is triggered by the human presence sensing circuitry when no one is detected for longer than a threshold period.

In Example 6, the subject matter of Examples 1-5 includes, wherein the human presence sensing circuitry comprises a camera or an infrared sensor.

In Example 7, the subject matter of Examples 1-6 includes, wherein the exception comprises receiving input from an input device connected to the portable device.

In Example 8, the subject matter of Example 7 includes, wherein the processor circuitry is to: reset a timer in response to receiving input from an input device connected to the portable device.

In Example 9, the subject matter of Examples 7-8 includes, wherein the input device comprises a mouse, a keyboard, or a touchpad.

In Example 10, the subject matter of Examples 1-9 includes, wherein the exception comprises receiving input from an input device connected to the wireless display device.

In Example 11, the subject matter of Example 10 includes, wherein the processor circuitry is to: reset a timer in response to receiving input from an input device connected to the wireless display device.

In Example 12, the subject matter of Examples 10-11 includes, wherein the input device comprises a mouse, a keyboard, or a touchpad.

In Example 13, the subject matter of Examples 1-12 includes, wherein the exception comprises receiving an indication of a user present event.

In Example 14, the subject matter of Example 13 includes, wherein the user present event is detected by the human presence sensing circuitry in the wireless display device.

In Example 15, the subject matter of Example 14 includes, wherein the user present event is based on detecting movement of a person in proximity of the wireless display device.

In Example 16, the subject matter of Examples 13-15 includes, wherein to control the state of the portable device to lock, resume, or disconnect, the processor circuitry is to: reset a timer in response to receiving the indication of the user present event.

In Example 17, the subject matter of Examples 1-16 includes, wherein the exception comprises determining that a video playback application is executing on the portable device with the output displayed on the wireless display device.

In Example 18, the subject matter of Example 17 includes, wherein to control the state of the portable device to lock, resume, or disconnect, the processor circuitry is to: reset a timer in response to determining that the video playback application is executing on the portable device.

In Example 19, the subject matter of Examples 1-18 includes, wherein to control the state of the portable device to lock, resume, or disconnect, the processor circuitry is to: lock at least one of the portable device or the wireless display device in response to no exception having been received in a threshold period after the user absent event.

In Example 20, the subject matter of Example 19 includes, wherein to control the state of the portable device to lock, resume, or disconnect, the processor circuitry is to: transition the portable device to a standby state after the portable device is locked for more than a threshold period.

Example 21 is a method for controlling states of a portable device when connected with a wireless display device, comprising: initiating an establishment of a wireless connection between the portable device and the wireless display device for the portable device to cast output to the wireless display device; receiving an indication of a user absent event, the user absent event triggered by human presence sensing circuitry of the wireless display device; determining whether an exception exists; and controlling a state of the portable device to lock, resume, or disconnect the portable device based on whether the exception exists.

In Example 22, the subject matter of Example 21 includes, wherein the wireless connection comprises a connection using the Miracast standard.

In Example 23, the subject matter of Examples 21-22 includes, wherein the wireless display device comprises a smart television, a monitor screen, or a desktop computer.

In Example 24, the subject matter of Examples 21-23 includes, wherein the indication of the user absent event is transmitted to the portable device from the wireless display device over a backchannel wireless connection.

In Example 25, the subject matter of Examples 21-24 includes, wherein the user absent event is triggered by the human presence sensing circuitry when no one is detected for longer than a threshold period.

In Example 26, the subject matter of Examples 21-25 includes, wherein the human presence sensing circuitry comprises a camera or an infrared sensor.

In Example 27, the subject matter of Examples 21-26 includes, wherein the exception comprises receiving input from an input device connected to the portable device.

In Example 28, the subject matter of Example 27 includes, resetting a timer in response to receiving input from an input device connected to the portable device.

In Example 29, the subject matter of Examples 27-28 includes, wherein the input device comprises a mouse, a keyboard, or a touchpad.

In Example 30, the subject matter of Examples 21-29 includes, wherein the exception comprises receiving input from an input device connected to the wireless display device.

In Example 31, the subject matter of Example 30 includes, resetting a timer in response to receiving input from an input device connected to the wireless display device.

In Example 32, the subject matter of Examples 30-31 includes, wherein the input device comprises a mouse, a keyboard, or a touchpad.

In Example 33, the subject matter of Examples 21-32 includes, wherein the exception comprises receiving an indication of a user present event.

In Example 34, the subject matter of Example 33 includes, wherein the user present event is detected by the human presence sensing circuitry in the wireless display device.

In Example 35, the subject matter of Example 34 includes, wherein the user present event is based on detecting movement of a person in proximity of the wireless display device.

In Example 36, the subject matter of Examples 33-35 includes, wherein controlling the state of the portable device to lock, resume, or disconnect comprises: resetting a timer in response to receiving the indication of the user present event.

In Example 37, the subject matter of Examples 21-36 includes, wherein the exception comprises determining that a video playback application is executing on the portable device with the output displayed on the wireless display device.

In Example 38, the subject matter of Example 37 includes, wherein controlling the state of the portable device to lock, resume, or disconnect comprises: resetting a timer in response to determining that the video playback application is executing on the portable device.

In Example 39, the subject matter of Examples 21-38 includes, wherein controlling the state of the portable device to lock, resume, or disconnect comprises: locking at least one of the portable device or the wireless display device in response to no exception having been received in a threshold period after the user absent event.

In Example 40, the subject matter of Example 39 includes, wherein controlling the state of the portable device to lock, resume, or disconnect comprises: transitioning the portable device to a standby state after the portable device is locked for more than a threshold period.

Example 41 is at least one machine-readable medium including instructions for controlling states of a portable device when connected with a wireless display device, which when executed by a machine, cause the machine to: initiate an establishment of a wireless connection between the portable device and the wireless display device for the portable device to cast output to the wireless display device; receive an indication of a user absent event, the user absent event triggered by human presence sensing circuitry of the wireless display device; determine whether an exception exists; and control a state of the portable device to lock, resume, or disconnect the portable device based on whether the exception exists.

In Example 42, the subject matter of Example 41 includes, wherein the wireless connection comprises a connection using the Miracast standard.

In Example 43, the subject matter of Examples 41-42 includes, wherein the wireless display device comprises a smart television, a monitor screen, or a desktop computer.

In Example 44, the subject matter of Examples 41-43 includes, wherein the indication of the user absent event is transmitted to the portable device from the wireless display device over a backchannel wireless connection.

In Example 45, the subject matter of Examples 41-44 includes, wherein the user absent event is triggered by the human presence sensing circuitry when no one is detected for longer than a threshold period.

In Example 46, the subject matter of Examples 41-45 includes, wherein the human presence sensing circuitry comprises a camera or an infrared sensor.

In Example 47, the subject matter of Examples 41-46 includes, wherein the exception comprises receiving input from an input device connected to the portable device.

In Example 48, the subject matter of Example 47 includes, instructions to: reset a timer in response to receiving input from an input device connected to the portable device.

In Example 49, the subject matter of Examples 47-48 includes, wherein the input device comprises a mouse, a keyboard, or a touchpad.

In Example 50, the subject matter of Examples 41-49 includes, wherein the exception comprises receiving input from an input device connected to the wireless display device.

In Example 51, the subject matter of Example 50 includes, instructions to: reset a timer in response to receiving input from an input device connected to the wireless display device.

In Example 52, the subject matter of Examples 50-51 includes, wherein the input device comprises a mouse, a keyboard, or a touchpad.

In Example 53, the subject matter of Examples 41-52 includes, wherein the exception comprises receiving an indication of a user present event.

In Example 54, the subject matter of Example 53 includes, wherein the user present event is detected by the human presence sensing circuitry in the wireless display device.

In Example 55, the subject matter of Example 54 includes, wherein the user present event is based on detecting movement of a person in proximity of the wireless display device.

In Example 56, the subject matter of Examples 53-55 includes, wherein the instructions to control the state of the portable device to lock, resume, or disconnect include instructions to: reset a timer in response to receiving the indication of the user present event.

In Example 57, the subject matter of Examples 41-56 includes, wherein the exception comprises determining that a video playback application is executing on the portable device with the output displayed on the wireless display device.

In Example 58, the subject matter of Example 57 includes, wherein the instructions to control the state of the portable device to lock, resume, or disconnect include instructions to: reset a timer in response to determining that the video playback application is executing on the portable device.

In Example 59, the subject matter of Examples 41-58 includes, wherein the instructions to control the state of the portable device to lock, resume, or disconnect include instructions to: lock at least one of the portable device or the wireless display device in response to no exception having been received in a threshold period after the user absent event.

In Example 60, the subject matter of Example 59 includes, wherein the instructions to control the state of the portable device to lock, resume, or disconnect include instructions to: transition the portable device to a standby state after the portable device is locked for more than a threshold period.

Example 61 is an apparatus for controlling states of a portable device when connected with a wireless display device, comprising: means for initiating an establishment of a wireless connection between the portable device and the wireless display device for the portable device to cast output to the wireless display device; means for receiving an indication of a user absent event, the user absent event triggered by human presence sensing circuitry of the wireless display device; means for determining whether an exception exists; and means for controlling a state of the portable device to lock, resume, or disconnect the portable device based on whether the exception exists.

In Example 62, the subject matter of Example 61 includes, wherein the wireless connection comprises a connection using the Miracast standard.

In Example 63, the subject matter of Examples 61-62 includes, wherein the wireless display device comprises a smart television, a monitor screen, or a desktop computer.

In Example 64, the subject matter of Examples 61-63 includes, wherein the indication of the user absent event is transmitted to the portable device from the wireless display device over a backchannel wireless connection.

In Example 65, the subject matter of Examples 61-64 includes, wherein the user absent event is triggered by the human presence sensing circuitry when no one is detected for longer than a threshold period.

In Example 66, the subject matter of Examples 61-65 includes, wherein the human presence sensing circuitry comprises a camera or an infrared sensor.

In Example 67, the subject matter of Examples 61-66 includes, wherein the exception comprises receiving input from an input device connected to the portable device.

In Example 68, the subject matter of Example 67 includes, means for resetting a timer in response to receiving input from an input device connected to the portable device.

In Example 69, the subject matter of Examples 67-68 includes, wherein the input device comprises a mouse, a keyboard, or a touchpad.

In Example 70, the subject matter of Examples 61-69 includes, wherein the exception comprises receiving input from an input device connected to the wireless display device.

In Example 71, the subject matter of Example 70 includes, means for resetting a timer in response to receiving input from an input device connected to the wireless display device.

In Example 72, the subject matter of Examples 70-71 includes, wherein the input device comprises a mouse, a keyboard, or a touchpad.

In Example 73, the subject matter of Examples 61-72 includes, wherein the exception comprises receiving an indication of a user present event.

In Example 74, the subject matter of Example 73 includes, wherein the user present event is detected by the human presence sensing circuitry in the wireless display device.

In Example 75, the subject matter of Example 74 includes, wherein the user present event is based on detecting movement of a person in proximity of the wireless display device.

In Example 76, the subject matter of Examples 73-75 includes, wherein the means for controlling the state of the portable device to lock, resume, or disconnect comprises: means for resetting a timer in response to receiving the indication of the user present event.

In Example 77, the subject matter of Examples 61-76 includes, wherein the exception comprises determining that a video playback application is executing on the portable device with the output displayed on the wireless display device.

In Example 78, the subject matter of Example 77 includes, wherein the means for controlling the state of the portable device to lock, resume, or disconnect comprises: means for resetting a timer in response to determining that the video playback application is executing on the portable device.

In Example 79, the subject matter of Examples 61-78 includes, wherein the means for controlling the state of the portable device to lock, resume, or disconnect comprises: means for locking at least one of the portable device or the wireless display device in response to no exception having been received in a threshold period after the user absent event.

In Example 80, the subject matter of Example 79 includes, wherein the means for controlling the state of the portable device to lock, resume, or disconnect comprises: means for transitioning the portable device to a standby state after the portable device is locked for more than a threshold period.

Example 81 is at least one machine-readable medium including instructions that, when executed by processing circuitry, cause the processing circuitry to perform operations to implement of any of Examples 1-80.

Example 82 is an apparatus comprising means to implement of any of Examples 1-80.

Example 83 is a system to implement of any of Examples 1-80.

Example 84 is a method to implement of any of Examples 1-80.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A portable device, comprising:
a memory configured to store instructions for controlling states of the portable device when connected with a wireless display device; and
a processor circuitry, which when configured by the instructions, is operable to:
initiate an establishment of a wireless connection between the portable device and the wireless display device for the portable device to cast output to the wireless display device;
receive an indication of a user absent event, the user absent event triggered by human presence sensing circuitry of the wireless display device;
determine whether an exception exists; and
control a state of the portable device to lock, resume, or
disconnect the portable device based on whether the exception exists.

2. The portable device of claim 1, wherein the wireless connection comprises a connection using the Miracast standard.

3. The portable device of claim 1, wherein the wireless display device comprises a smart television, a monitor screen, or a desktop computer.

4. The portable device of claim 1, wherein the indication of the user absent event is transmitted to the portable device from the wireless display device over a backchannel wireless connection.

5. The portable device of claim 1, wherein the user absent event is triggered by the human presence sensing circuitry when no one is detected for longer than a threshold period.

6. The portable device of claim 1, wherein the human presence sensing circuitry comprises a camera or an infrared sensor.

7. The portable device of claim 1, wherein the exception comprises receiving input from an input device connected to the portable device.

8. The portable device of claim 7, wherein the processor circuitry is to:
reset a timer in response to receiving input from an input device connected to the portable device.

9. The portable device of claim 7, wherein the input device comprises a mouse, a keyboard, or a touchpad.

10. The portable device of claim 1, wherein the exception comprises receiving input from an input device connected to the wireless display device.

11. The portable device of claim 10, wherein the processor circuitry is to:
reset a timer in response to receiving input from an input device connected to the wireless display device.

12. The portable device of claim 10, wherein the input device comprises a mouse, a keyboard, or a touchpad.

13. The portable device of claim 1, wherein the exception comprises receiving an indication of a user present event.

14. The portable device of claim 13, wherein the user present event is detected by the human presence sensing circuitry in the wireless display device.

15. The portable device of claim 14, wherein the user present event is based on detecting movement of a person in proximity of the wireless display device.

16. The portable device of claim 13, wherein to control the state of the portable device to lock, resume, or disconnect, the processor circuitry is to:
reset a timer in response to receiving the indication of the user present event.

17. The portable device of claim 1, wherein the exception comprises determining that a video playback application is executing on the portable device with the output displayed on the wireless display device.

18. The portable device of claim 17, wherein to control the state of the portable device to lock, resume, or disconnect, the processor circuitry is to:
reset a timer in response to determining that the video playback application is executing on the portable device.

19. The portable device of claim 1, wherein to control the state of the portable device to lock, resume, or disconnect, the processor circuitry is to:
lock at least one of the portable device or the wireless display device in response to no exception having been received in a threshold period after the user absent event.

20. The portable device of claim 19, wherein to control the state of the portable device to lock, resume, or disconnect, the processor circuitry is to:
transition the portable device to a standby state after the portable device is locked for more than a threshold period.

21. At least one machine-readable medium including instructions for controlling states of a portable device when connected with a wireless display device, which when executed by a machine, cause the machine to:
initiate an establishment of a wireless connection between the portable device and the wireless display device for the portable device to cast output to the wireless display device;
receive an indication of a user absent event, the user absent event triggered by human presence sensing circuitry of the wireless display device;
determine whether an exception exists; and
control a state of the portable device to lock, resume, or disconnect the portable device based on whether the exception exists.

22. The at least one machine-readable medium of claim 21, wherein the exception comprises receiving an indication of a user present event.

23. The at least one machine-readable medium of claim 22, wherein the user present event is detected by the human presence sensing circuitry in the wireless display device.

24. The at least one machine-readable medium of claim 23, wherein the user present event is based on detecting movement of a person in proximity of the wireless display device.

25. The at least one machine-readable medium of claim 22, wherein the instructions to control the state of the portable device to lock, resume, or disconnect include instructions to:
reset a timer in response to receiving the indication of the user present event.
